(19) United States
(12) Patent Application Publication
(10) Pub. No.: US 2010/0111766 A1
(43) Pub. Date: May 6, 2010

(54) AUTOMATIC ANALYSIS APPARATUS AND OPERATION METHOD THEREOF

(75) Inventors: Hai WANG, Shenzhen (CN); Zhi XU, Shenzhen (CN); Chuanfen XIE, Shenzhen (CN); Xuezheng WANG, Shenzhen (CN)

Correspondence Address: Mindray c/o Vista IP Law Group LLP, 1885 Lundy Avenue, Suite 108, San Jose, CA, 95131, US

(73) Assignee: Shenzhen Mindray Bio-Medical Electronics Co., Ltd., Shenzhen (CN)

(21) Appl. No.: 12/610,182

(22) Filed: Oct. 30, 2009

(30) Foreign Application Priority Data
Oct. 31, 2008 (CN) 200810217189.4

(51) Int. Cl. G01N 21/00

(52) U.S. Cl. 422/64

(57) ABSTRACT

Disclosed is an automatic analysis apparatus and its operation method. The apparatus includes a reaction disk for carrying cuvettes and driving the cuvettes to rotate or to stop at predetermined positions, a reagent dispensing mechanism for injecting a reagent into the cuvettes, and a sample dispensing mechanism for injecting a sample into the cuvettes. The reagent dispensing mechanism includes a reagent needle, and the sample dispensing mechanism includes a sample needle. In each working cycle, the reaction disk is started to move and stopped at least twice respectively, and the reagent needle and the sample needle perform corresponding adding operations to the cuvette in different stopping stages. The approach may perform different tests in lower cost, can avoid restriction to the relative position of the needles, and is beneficial to the overall layout design of the apparatus.

### CROSS-REFERENCE TO RELATED APPLICATIONS

The present application claims priority to Chinese Patent Application No. 200810217189.4, filed on Oct. 31, 2008, which is hereby incorporated by reference in its entirety.

### TECHNICAL FIELD

The invention relates to an automatic analysis apparatus for analyzing reaction liquids which are injected to a reaction vessel in the form of a sample and a reagent, and an operation method of the automatic analysis apparatus.

### BACKGROUND ART

Automatic biochemical analyzers are biochemical analysis equipments which are now generally used for testing various biochemical indexes of blood, urine or other body liquids in clinical laboratories. An automatic biochemical analyzer performs a series of operations for biochemical analysis, in a manner to imitate manual operations, including adding agent, adding sample, mixing, thermostatic reaction, measuring of light absorbency, and results calculation. An automatic biochemical analyzer is mainly composed of a reaction disk (including a thermostat system), a sample disk (or a sample rack), a reagent disk, a sample dispensing mechanism, a reagent dispensing mechanism, an agitating mechanism, a cuvette cleaning device, and a user operating system.

A plurality of cuvettes are arranged on the reaction disk. For each cuvette, its operation procedure includes: 1, cleaning the cuvette by means of the cleaning device; 2, moving the cuvette by means of the reaction disk to a reagent adding position, and adding a first reagent into the cuvette by means of the reagent dispensing mechanism; 3, moving the cuvette to a sample adding position by means of the reaction disk, and adding a sample into the cuvette by means of the sample dispensing mechanism; 4, if necessary, adding a second reagent or even additionally add a third reagent into the cuvette by means of the reagent dispensing mechanism; and then 5, during a reaction period, measuring light absorbency during the testing process.

If the whole structure of the analyzer is not properly designed, then a sample needle for adding sample and a reagent needle for adding reagent may interfere with each other. In addition, if the time sequence for adding reagent and adding sample is not properly designed, then the two needles may suffer from strict restriction on their relative positions, which will negatively influence the optimized arrangement of the structure, for example, resulting in an increased total number of components, creating a bulk structure, and/or resulting in high cost.

### SUMMARY OF INVENTION

An object of some embodiments of the invention is to provide an automatic analysis apparatus and an operation method thereof, in which a proper operation time sequence can be designed on the basis of an optimized overall structure of the automatic analysis apparatus.

To this end, some embodiments of the invention provide an automatic analysis apparatus comprising: a reaction disk configured to carry cuvettes and drive the cuvettes to rotate or to stop at predetermined positions; a reagent dispensing mechanism arranged near the rotation path of the reaction disk and configured to inject a reagent into the cuvettes; and a sample dispensing mechanism arranged near the rotation path of the reaction disk and configured to inject a sample into the cuvettes; wherein the reagent dispensing mechanism comprises a reagent needle, and the sample dispensing mechanism comprises a sample needle; and wherein, in each working cycle, the reaction disk is started to move and stopped at least twice respectively; and in each stopping stage, an adding operation which is corresponding to this stopping stage is performed according to a pre-determined setting.

Some embodiments further provide an automatic analysis apparatus comprising: a reaction disk configured to carry cuvettes and drive the cuvettes to rotate or to stop at predetermined positions; a reagent dispensing mechanism arranged near the rotation path of the reaction disk and configured to inject a reagent into the cuvettes; and a sample dispensing mechanism arranged near the rotation path of the reaction disk and configured to inject a sample into the cuvettes; wherein the reagent dispensing mechanism comprises a reagent needle, and the sample dispensing mechanism comprises a sample needle; and wherein, in each working cycle, the reaction disk is started to move and stopped at least twice respectively, and the reagent needle and the sample needle perform corresponding adding operations to the cuvette in different stopping stages.

Some embodiments further provide an operation method of an automatic analysis apparatus, the automatic analysis apparatus comprising: a reaction disk configured to carry cuvettes and drive the cuvettes to rotate or to stop at predetermined positions; a reagent dispensing mechanism arranged near the rotation path of the reaction disk and configured to inject a reagent into the cuvettes; and a sample dispensing mechanism arranged near the rotation path of the reaction disk and configured to inject a sample into the cuvettes; wherein the reagent dispensing mechanism comprises a reagent needle, and the sample dispensing mechanism comprises a sample needle; Wherein the operation method comprises the steps of: in each working cycle, the reaction disk is started to move and stopped at least twice respectively; an adding operation is preset for each stopping stage; and when the reaction disk is in one of the stopping stages, the automatic analysis apparatus performs an adding operation which is corresponding to this stopping stage.

An operation method is further provided for an automatic analysis apparatus, the automatic analysis apparatus comprising: a reaction disk configured to carry cuvettes and drive the cuvettes to rotate or to stop at predetermined positions; a reagent dispensing mechanism arranged near the rotation path of the reaction disk and configured to inject a reagent into the cuvettes; and a sample dispensing mechanism arranged near the rotation path of the reaction disk and configured to inject a sample into the cuvettes; wherein the reagent dispensing mechanism comprises a reagent needle, and the sample dispensing mechanism comprises a sample needle; wherein the operation method comprises the steps of: in each working cycle, the reaction disk is started to move and stopped at least twice respectively, and the reagent needle and the sample needle perform corresponding adding operations to the cuvette in different stopping stages.

### BRIEF DESCRIPTION OF THE DRAWINGS

FIG. 1 is a schematic view showing the layout of the overall structure of an automatic analysis apparatus of the invention;

FIG. 2 is a schematic diagram of a single-reagent testing mode of the automatic analysis apparatus;

FIG. 3 is a schematic diagram of a double-reagent testing mode of the automatic analysis apparatus;

FIG. 4 is a schematic diagram of a normormal cycle (triple-reagent testing mode) of the automatic analysis apparatus; and

FIG. 5 is a schematic diagram of a normormal cycle (antigen re-adding testing mode) of the automatic analysis apparatus.

### DETAILED DESCRIPTION

The features and advantages of the invention will be described in details by way of preferred embodiments with reference to the drawings.

An automatic analysis apparatus according to an embodiment of the invention comprises a reaction disk, a sample needle and a reagent needle, the sample needle and the reagent needle being carried by a sample dispensing mechanism and a reagent dispensing mechanism respectively. The reaction disk carries cuvettes and drives the cuvettes to rotate or stop at predetermined positions. The reagent dispensing mechanism is arranged near the rotation path of the reaction disk, for injecting a reagent into a cuvette by means of the reagent needle carried by the reagent dispensing mechanism. The sample dispensing mechanism is also arranged near the rotation path of the reaction disk, for injecting a sample into a cuvette by means of the sample needle carried by the sample dispensing mechanism.

Based on this configuration, which includes one reaction disk, one sample needle and one reagent needle, an operation time sequence that can be performed that may be composed as: in each working cycle, the reaction disk is started to move and stopped at least twice respectively; and in different stopping stages, the automatic analysis apparatus performs different adding operations. Thus, for each stopping stage, a corresponding adding operation should be predetermined so that, when the reaction disk is in one of the stopping stages, the automatic analysis apparatus performs an adding operation which is corresponding to this stopping stage. The adding operation may include adding a first reagent, adding a sample, adding a second reagent, or adding a normormal injection liquid. By way of example, in each stopping stage, a liquid selected from a group of a first reagent, a sample, a second reagent and a normormal injection liquid is added into the cuvette. In some embodiments, an adding operation which is corresponding to a certain stopping stage may also be null operation, i.e., no adding operation is performed, and the sample dispensing mechanism or the reagent dispensing mechanism keeps stationary in this stopping stage.

A working cycle is defined as a time period between a sample adding operation and the next sample adding operation. In each working cycle, the components of the apparatus cooperate precisely in accordance with a pre-determined action sequence to perform adding a first reagent, adding a sample, adding a second reagent and similar operations sequentially to a ring of cuvettes on the reaction disk, so that the test to a large quantity of biochemical items can be carried out quickly. Each working cycle is divided into several starting stages and stopping stages according to the starting and stopping of the reaction disk. The reagent needle and the sample needle perform different adding operations into the cuvettes in different stopping stages. Thus, adding a sample, adding a first reagent and adding a second reagent can be finished in the same working cycle. Further, since the reagent needle and the sample needle operate in different stopping stages, that is to say, the reagent and the sample are added in different stopping stages of the reaction disk, the reagent needle and the sample needle will not interfere with each other, and any restriction to the relative position between the reagent needle and the sample needle is avoided, which is benefit to the overall layout design of the apparatus. In this embodiment, the reaction disk, in each stopping stage, in accordance with a pre-determined setting, stops the cuvette at a location of an additive which is corresponding to this stopping stage. The location of the additive is where the sample dispensing mechanism locates the sample needle to add a sample (or sample adding position) or where the reagent dispensing mechanism locates the reagent needle to add a reagent (or reagent adding position).

Each apparatus may include only one reaction disk, one sample needle and one reagent needle. Alternatively, there may be several reaction disks, sample needles and reagent needles, but only one reaction disk, one sample needle and one reagent needle are related with each operation time sequence of the invention.

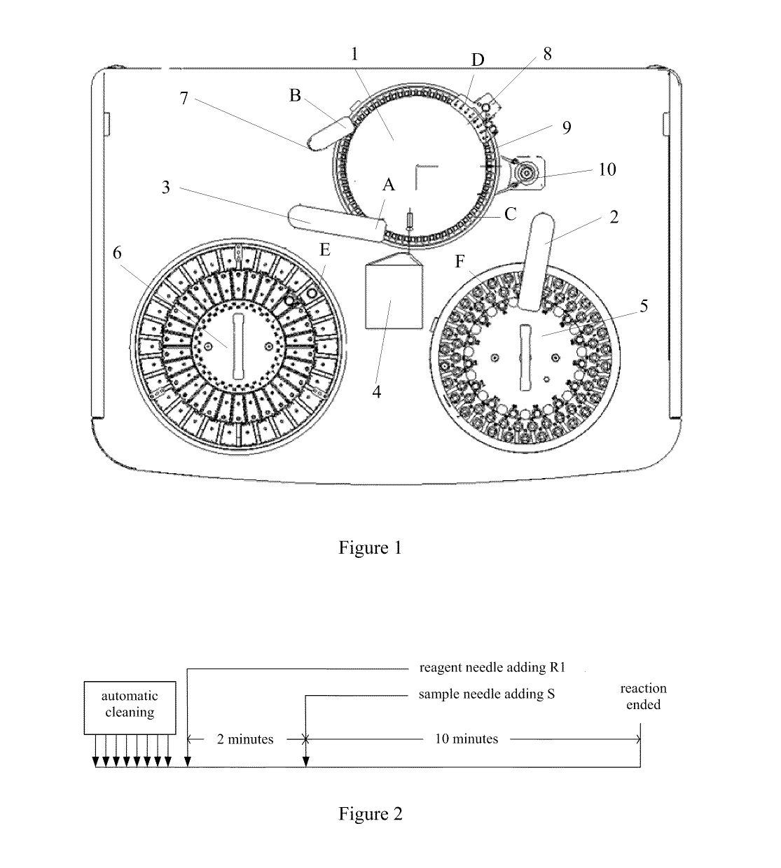

FIG. 1 shows an embodiment of a layout of an automatic analysis apparatus of the invention. The automatic analysis apparatus comprises a reaction disk 1, a sample needle 2 and a reagent needle 3, the sample needle 2 and the reagent needle 3 being carried by a sample dispensing mechanism and a reagent dispensing mechanism (not shown) respectively. The apparatus may further comprise a photoelectric detector 4, a sample disk 5, a reagent disk 6, an agitator 7 and an automatic cleaning station 8.

The reaction disk 1 is arranged on the back-middle part of a table of the apparatus, so that the operation of the reaction disk is not likely to be disturbed. The reaction disk has a circumferentially arranged structure, on which a plurality of cuvettes 9 are disposed in equal circumferential spacing. Each cuvette may function as a vessel for containing a reaction liquid and proving reaction condition to it, or even function as a colorimetric vessel. The cuvettes may be disposable or reusable (in this embodiment, reusable cuvettes are employed). The reaction disk is rotatably driven by a reaction disk driver 10 around a central rotational axis of the reaction disk.

If reusable cuvettes are used, a cleaning station for cleaning the cuvettes should be provided. The cleaning station 8 shown in FIG. 1 is arranged at a position back-right from the reaction disk 1. Each cuvette 9 after test is automatically cleaned when it is stopped at the cleaning station 8, for preparation for the next test.

The sample needle 2 is arranged at a position front-right from the reaction disk 1, and is located at a proper position between the reaction disk 1 and the sample disk 5. The movement pathway of the sample needle 2 during its movement covers both the reaction disk 1 and the sample disk 5. During test, the sample needle 2 sucks up a sample from the sample disk 5, and injects the sample into a corresponding one of the cuvettes 9 arranged on the reaction disk 1.

The sample disk 5 is arranged on the front-right part of the table of the apparatus, so that the sample can be sucked up and injected easily.

The reagent needle 3 is arranged at a position front-left from the reaction disk 1, and is located at a proper position between the reaction disk 1 and the reagent disk 6. The movement pathway of the reagent needle 3 during its movement covers both the reaction disk 1 and the reagent disk 5. During test, the reagent needle 3 sucks up a reagent from the reagent disk 6, and injects the reagent into a corresponding one of the cuvettes 9 arranged on the reaction disk 1.

The reagent disk 6 is arranged on the front-left part of the table of the apparatus, so that the reagent can be sucked up and injected easily.

Since during test a cuvette is added with a reagent and a sample as different reaction liquids, in an embodiment an agitator is provided for agitating the reaction liquids into a uniform state for achieving a sufficient reaction. The agitator 7 is arranged at a position back-left from the reaction disk 1, so that any hurt to operators during operation is avoided. Further, in this embodiment, agitating the sample after the sample is added and agitating the reagent after the reagent is added are performed at the same position, so that no further agitator is needed and the cost of the apparatus can be reduced.

Further, the photoelectric detector 4 is arranged in front of the reaction disk 1, for photoelectric testing the cuvettes moving in the testing scope of the photoelectric detector 4 during the rotation of the reaction disk 1. Arranging the photoelectric detector 4 in front of the reaction disk 1 facilitates the check and maintenance of the photoelectric detector.

The overall layout of the automatic analysis apparatus has been described above with reference to preferred embodiments. Several factors, such as the manipulability of the operators to the reagent and the sample, maintenance of important components, protection of operators, and the like, have been considered in the design of the overall layout. Meanwhile, the automatic analysis apparatus has a compact overall structure, which helps to save space and material.

FIG. 1 shows an embodiment of the overall layout of the apparatus. However, the components of the apparatus may be arranged and positioned in other ways according to real condition to meet the requirement of operation time sequence.

Now embodiments of the test procedure performed by the apparatus of the invention will be described. First, the reagent needle adds a first reagent into one of the cuvettes; then, after a fixed time period which is sufficient for the added first reagent to be incubated to reach a temperature required by reaction. Then the sample needle adds a sample, and then agitating is performed. If it is a single-reagent testing procedure, then the reaction is initiated after the sample is added, and the reaction is ended when a pre-determined reaction time period has past. If it is a double-reagent testing procedure, then the sample is added, and then agitating is performed; then, after an incubation time period which is sufficient to eliminate interference reactions in double reagent testing procedure, the reagent needle adds a second reagent, and then agitating is performed; and then after a pre-determined reaction time period has past, the reaction is ended. If an automatic cleaning mechanism is provided for the cuvettes, then the cuvettes which have finished test can be cleaned while other cuvettes are under test.

Based on the overall structure of the apparatus and in combination with its operation method, adding a sample, adding a first reagent and adding a second reagent can be performed in the same working cycle. If an automatic cleaning device is provided for the cuvettes, then a constant testing velocity for single- or double-reagent testing procedure can be achieved. Thus, the invention can provide a typical constant-velocity testing mode by means of a simple configuration, by which constant-velocity testing procedure of two or more reagents can be performed.

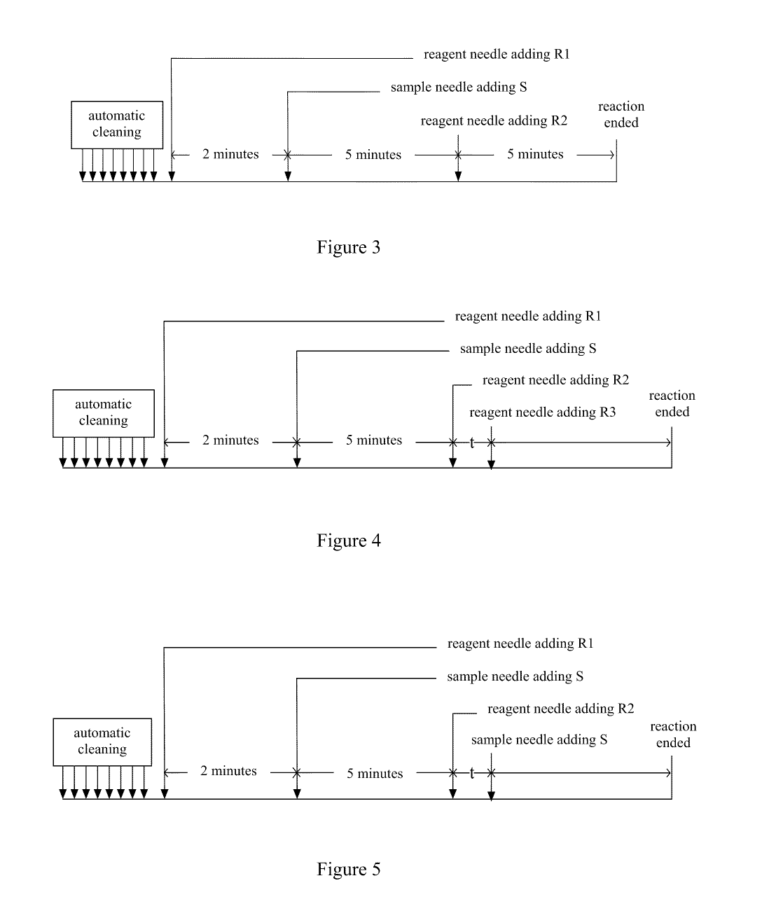

The single- and double-reagent testing modes are showing in FIGS. 2 and 3 respectively. FIG. 2 shows the operation of a single-reagent testing mode, in which the cuvette after automatic cleaning is added with a first reagent R1 by the reagent needle. After 2 minutes, the sample needle adds a sample S into the cuvette, and then a reaction time period of 10 minutes is experienced. FIG. 3 shows the operation of a double-reagent testing mode, in which the cuvette after automatic cleaning is added with a first reagent R1 by the reagent needle. After 2 minutes, the sample needle adds a sample S into the cuvette. Then, after 5 minutes, the reagent needle adds a second reagent R2 into the cuvette, and then a reaction time period of 5 minutes is experienced.

For supporting the above two testing modes, the operation method according to an embodiment may includes a series of working cycles. In each working cycle, the components of the apparatus work in accordance with a pre-determined action sequence, that is, adding a sample, adding a first reagent, adding a second reagent, agitating, photoelectrical gathering of dada, and automatic cleaning of cuvettes. In this way, the working cycles are continued repetitively, so that more than one testing procedure can be performed in high efficiency.

According to different testing combinations, the actions to be performed during each cycle may include one or more actions described above. Thus, for setting the action sequence of each cycle, only all the necessary actions to be completed will be considered as design basis. If only some of the actions need to perform in a certain working cycle, that is, if in a working cycle there is a certain stopping stage in which a predetermined operation correlated with this stopping stage should not be performed, then the component related with this operation keeps stationary in this stopping stage.

All the actions to be performed in a working cycle according to an embodiment of an action sequence will be described now.

In a working cycle, a reaction disk starts counterclockwise rotation and stops three times respectively. During each working cycle, the reaction disk rotates in counterclockwise direction by an angle of two complete turns subtracting an angle occupied by a cuvette. That is to say, after each working cycle, the reaction disk will be located in an angular position which is advancing in clockwise direction with respect to its original angular position by an angle occupied by a cuvette.

Specifically, when each cycle is initiated, the reaction disk is rotated the first time through a certain angle according to a pre-determined setting, so that a cuvette which is to be added with a second reagent is located at reagent adding position “A” and is stopped there. The reagent needle at position “A” adds the required second reagent into this cuvette.

After the above action, the reaction disk is rotated the second time through a certain angle according to a pre-determined setting, so that a cuvette which is to be added with a first reagent is located at reagent adding position “A” and is stopped there. The reagent needle at position “A” adds the required first reagent into this cuvette; during this stopping stage, the agitator performs a sample agitating action to the cuvette which is stopped at position “B”.

After the above action, the reaction disk is rotated the third time through a certain angle according to a pre-determined setting, so that a cuvette which is to be added with a sample is located at sample adding position “C” and is stopped there. The sample needle at position “C” adds the required sample into the cuvette; during this stopping stage, the agitator performs a reagent agitating action to the cuvette which is stopped at position “B”, and the cleaning station performs an automatic cleaning operation to the cuvette which is stopped at position “D”.

During the rotation of the reaction disk, the photoelectric detector performs photoelectric test to the cuvette passing through it. If necessary, the test result will be calculated in combination with the data related with a selected time point and a predetermined wavelength.

In each testing procedure, in cooperative with the actions of the reaction disk and the reagent needle, the total amount of the required reagent has been put to a predetermined position in the reagent disk. Before the reagent needle adding the first reagent or the second reagent into the reaction disk, the reagent disk locates the required reagent to a reagent suction position “E”, and then the reagent needle at the reagent suction position “E” sucks up the required first or second reagent.

In each testing procedure, in cooperative with the actions of the reaction disk and the sample needle, the total amount of the required sample has been put to a predetermined position in the sample disk. Before the sample needle adding the sample into the reaction disk, the sample disk locates the required sample to a sample suction position “F”, and the sample needle at the sample suction position “F” sucks up the required sample.

In an operation time sequence, it may decide to perform a particular operation at a particular stopping stage according to actual need. By way of example, it may be decided to add the first reagent during the first stopping stage; that is to say, after the reaction disk is rotated through a certain angle, a cuvette which is to be added with a first reagent is located at reagent adding position “A” and is stopped there, and the reagent needle at position “A” adds the required first reagent into the cuvette. Further, it may be decided to add the sample during the second stopping stage; that is to say, after the reaction disk is rotated through a certain angle, a cuvette which is to be added with a sample is located at reagent adding position “C” and is stopped there, and the reagent needle at position “C” adds the required sample into the cuvette. Furthermore, it may be decided to add the second reagent during the third stopping stage; that is to say, after the reaction disk is rotated through a certain angle, a cuvette which is to be added with a second reagent is located at reagent adding position “A” and is stopped there, and the reagent needle at position “A” adds the required second reagent into the cuvette.

The agitating operation of the agitator includes sample agitating and second reagent agitating according to particular needs, wherein the sample agitating stage is spaced from the sample adding stage by a stopping stage, and the second reagent agitating stage is spaced from the second reagent adding stage by a stopping stage.

The cleaning device may perform cleaning operation in any stopping stage according to a preset. For example, the cleaning operation may be performed in the last stopping stage of each working cycle or in stopping stage for adding the sample.

The above embodiments disclose an apparatus having an automatic cleaning configuration. Alternatively, the automatic cleaning station may be eliminated, and disposable cuvettes, which can be loaded and unloaded manually or automatically, can be used for this configuration.

The above embodiments disclose that reagent agitating and sample agitating are performed at the same agitating position. Alternatively, the reagent agitating position and the sample agitating position may be provided in different positions respectively.

The above embodiments disclose a test procedure of constant velocity for single- or double-reagent testing procedure. Alternatively, in real practice the invention may be used for a test procedure of constant velocity for triple- or even more-reagent testing procedure. In these cases, the reaction disk should be stopped several times in each cycle; the reagent needle and the sample needle add a first reagent, a sample, a second reagent and a third reagent or even more reagent respectively in different stopping stages, as shown in FIG. 4, wherein the time period “t” between adding the second reagent and adding the third reagent is fixed and thus can not be set.

Further, as a modification to the above embodiment, a triple- or even more-reagent testing procedure can be performed by adding one or more normal cycles at the cost of lowered testing speed. FIG. 4 shows an embodiment for this modification for carrying out a triple-reagent testing mode, in which the third reagent is added by the reagent needle in a certain stopping stage. In this condition, the time point for adding the third reagent can be set.

In a further modification, the sample may be added again into the cuvette by adding a normormal cycle at the cost of lowered testing speed. In this modification, an antigen re-adding text can be performed, wherein the antigen re-adding time point can be determined according to real condition. FIG. 5 shows an antigen re-adding testing mode that can be achieved by this modification, wherein the sample re-adding time point can be set.

As described above, the automatic analysis apparatus of the invention may use only one reaction disk in cooperative with one reagent needle and one sample needle for performing reagent and sample adding actions respectively. The invention is featured in that, in each working cycle, the reaction disk is started to move and stopped several times, and in different stopping stages, a sample, a first reagent and a second reagent or even more reagents are added. Single-, double- or even more-agent testing in constant velocity can be performed by the invention in a lower cost. Further, by designing of operation time sequence, adding reagent and adding sample can be done in different stopping stages of the reaction disk, so that any restriction to the relative positional relations of the reagent needle, the sample needle and the agitating bar of the agitator with respect to the reaction disk can be avoided. Thus, the apparatus can be designed to have a proper layout which is compact and in which the operation habit of users has be taken into consideration.

The present invention is described with reference to its preferred embodiments which are not intended to restrict the scope of the present invention. One skilled in the art will readily recognize that modifications and changes can be made to the embodiments without departing from the spirit of the present invention, and accordingly all these modifications and changes may be regarded as falling within the scope of the present invention.

1. An automatic analysis apparatus, comprising:
a reaction disk configured to carry cuvettes and drive the cuvettes to rotate or to stop at predetermined positions;
a reagent dispensing mechanism arranged near the rotation path of the reaction disk and configured to inject a reagent into the cuvettes; and
a sample dispensing mechanism arranged near the rotation path of the reaction disk and configured to inject a sample into the cuvettes;
wherein the reagent dispensing mechanism comprises a reagent needle, and the sample dispensing mechanism comprises a sample needle; and wherein, in each working cycle, the reaction disk is started to move and stopped at least twice respectively; and in each stopping stage, an adding operation which is corresponding to this stopping stage is performed according to a pre-determined setting.

2. The automatic analysis apparatus of claim 1, wherein the adding operation comprises at least one of adding a first reagent, adding a sample, adding a second reagent and adding a normormal injection liquid.

3. An automatic analysis apparatus, comprising:
a reaction disk configured to carry cuvettes and drive the cuvettes to rotate or to stop at predetermined positions;
a reagent dispensing mechanism configured to inject a reagent into the cuvettes; and
a sample dispensing mechanism configured to inject a sample into the cuvettes;
wherein the reagent dispensing mechanism comprises a reagent needle, and the sample dispensing mechanism comprises a sample needle; and wherein, in each working cycle, the reaction disk is started to move and stopped at least twice respectively, and the reagent needle and the sample needle perform corresponding adding operations to the cuvette in different stopping stages.

4. The automatic analysis apparatus of claim 3, wherein the reaction disk in each cycle is started to move and stopped three times respectively, and the reagent needle and the sample needle adds a first reagent, a sample and a second reagent into the cuvette in different stopping stages respectively.

5. The automatic analysis apparatus of claim 3, further comprising an agitator arranged near the rotation path of the reaction disk, the agitator, in a predetermined stopping stage in each working cycle, performs an agitating operation for a predetermined purpose to the reaction liquid contained in the cuvette which is stopped at the agitating position.

6. The automatic analysis apparatus of claim 5, wherein the sample agitating stage of the agitator is spaced from the sample adding stage by a stopping stage, and the second reagent agitating stage of the agitator is also spaced from the second reagent adding stage by a stopping stage.

7. The automatic analysis apparatus of claim 5, wherein the agitator performs agitating operations for different purposes at the same position.

8. The automatic analysis apparatus of claim 3, further comprising a cleaning device arranged near the rotation path of the reaction disk, and the cleaning device, in a predetermined stopping stage in each working cycle, performs a cleaning operation to the cuvette which is stopped at the cleaning position.

9. An operation method of an automatic analysis apparatus, the automatic analysis apparatus comprising: a reaction disk configured to carry cuvettes and drive the cuvettes to rotate or to stop at predetermined positions; a reagent dispensing mechanism arranged near the rotation path of the reaction disk and configured to inject a reagent into the cuvettes; and a sample dispensing mechanism arranged near the rotation path of the reaction disk and configured to inject a sample into the cuvettes; wherein the reagent dispensing mechanism comprises a reagent needle, and the sample dispensing mechanism comprises a sample needle;
wherein the operation method comprises the steps of: in each working cycle, the reaction disk is started to move and stopped at least twice respectively; an adding operation is preset for each stopping stage; and when the reaction disk is in one of the stopping stages, the automatic analysis apparatus performs an adding operation which is corresponding to this stopping stage.

10. The operation method of claim 9, wherein the adding operation comprises at least one of adding a first reagent, adding a sample, adding a second reagent and adding a normormal injection liquid.

11. An operation method of an automatic analysis apparatus, the automatic analysis apparatus comprising: a reaction disk configured to carry cuvettes and drive the cuvettes to rotate or to stop at predetermined positions; a reagent dispensing mechanism arranged near the rotation path of the reaction disk and configured to inject a reagent into the cuvettes; and a sample dispensing mechanism arranged near the rotation path of the reaction disk and configured to inject a sample into the cuvettes; wherein the reagent dispensing mechanism comprises a reagent needle, and the sample dispensing mechanism comprises a sample needle;
wherein the operation method comprises the steps of: in each working cycle, the reaction disk is started to move and stopped at least twice respectively, and the reagent needle and the sample needle perform corresponding adding operations to the cuvette in different stopping stages.

12. The operation method of claim 11, wherein the reaction disk in each cycle is started to move and stopped three times respectively, and the reagent needle and the sample needle adds a first reagent, a sample and a second reagent into the cuvette in different stopping stages respectively.

13. A method for operating an automatic analysis apparatus, comprising:
rotating a reaction disk to rotate or stop at predetermined positions during a working cycle, wherein the reaction disk is configured to carry cuvettes;
injecting a reagent into the cuvettes at a first of the predetermined locations;
injecting a sample into the cuvettes at a second of the predetermined location;
wherein in the working cycle, the reaction disk is started and stopped at least twice respectively, and the reagent and the sample are corresponding adding injected to the cuvettes in the different stopping stages.

14. The method of claim 13, wherein the reaction disk in the working cycle is started to move and stopped three times respectively, and a second reagent is injected into the cuvettes in different stopping stages respectively.
